(19) United States
(12) Patent Application Publication
(10) Pub. No.: US 2013/0176291 A1
(43) Pub. Date: Jul. 11, 2013

(54) METHODS AND DEVICES FOR CONTROLLING DISPLAY IN RESPONSE TO DEVICE ORIENTATION AND AMBIENT LIGHT LEVELS

(71) Applicant: Stephen Wesley Leonard, Unionville (CA)

(72) Inventor: Stephen Wesley Leonard, Unionville (CA)

(21) Appl. No.: 13/733,172

(22) Filed: Jan. 3, 2013

Related U.S. Application Data
(60) Provisional application No. 61/583,608, filed on Jan. 6, 2012.

(51) Int. Cl. G09G 5/10

(52) U.S. Cl. CPC G09G 5/10
USPC 345/207

(57) ABSTRACT

Devices and methods are provided for controlling a display of a portable display device based on input form a plurality of ambient light photosensors positioned proximal to edges of the display. The display device includes one or more orientation sensors configured such that processing circuitry of the display device may determine, based on input from the orientation sensors, an operative orientation of the device relative to gravity, and subsequently identify an uppermost display edge. Signals from the ambient light photosensors proximal to the uppermost display edge are employed to control the display.

### CROSS-REFERENCE TO RELATED APPLICATION

This application claims priority to U.S. Provisional Application No. 61/583,608, titled “METHODS AND DEVICES FOR CONTROLLING DISPLAY IN RESPONSE TO DEVICE ORIENTATION AND AMBIENT LIGHT LEVELS” and filed on Jan. 6, 2012, the entire contents of which is incorporated herein by reference.

### BACKGROUND

Mobile display devices have become increasingly ubiquitous, as smartphones, tablets, electronic readers, convertible ultrabooks, and other mobile computing devices continue to be adopted at by consumers globally. Such devices often include touch sensitive displays, such as capacitive or resistive touchscreens. Many touch sensitive devices, such as smartphones, tablets, and convertible ultrabooks, include displays that are capable of dynamic reorientation based on the physical orientation of the device.

Dynamic display reorientation is advantageous in enabling mobile display devices to be used with greater flexibility and agility. Unfortunately, display performance may be compromised when dynamic display reorientation is employed in concert with adaptive display dimming, where the brightness of a display is determined by a sensed level of ambient light.

### SUMMARY

Devices and methods are provided for controlling a display of a portable display device based on input form a plurality of ambient light photosensors positioned proximal to edges of the display. The display device includes one or more orientation sensors configured such that processing circuitry of the display device may determine, based on input from the orientation sensors, an operative orientation of the device relative to gravity, and subsequently identify an uppermost display edge. Signals from the ambient light photosensors proximal to the uppermost display edge are employed to control the display.

Accordingly, in one aspect, there is provided a mobile display device comprising:

a display configured for displaying an upright image in two or more operative orientations, each operative orientation having associated therewith a display edge that is positioned in an uppermost orientation;

one or more orientation sensors;

a plurality of photosensors configured to detect ambient light, wherein at least one photosensor is located proximal to each said display edge; and

processing circuitry operatively connected to said display, said orientation sensors, and said photosensors;

wherein said processing circuitry is configured to:
identify the operative orientation of said device with respect to gravity in response to input provided from said orientation sensors;
identify the uppermost display edge corresponding to the identified operative orientation;
display an upright image on said display; and
control said display according to input from one or more photosensors proximal to the identified uppermost display edge.

In another aspect, there is provided a computer implemented method of controlling a display on a mobile display device;

the mobile display device comprising:
a display configured for displaying an upright image in two or more operative orientations, each operative orientation having associated therewith a display edge that is positioned in an uppermost orientation;
one or more orientation sensors;
a plurality of photosensors configured to detect ambient light, wherein at least one photosensor is located proximal to each said display edge; and
processing circuitry operatively connected to said display, said orientation sensors, and said photosensors;

the method comprising:
identifying the operative orientation of said device with respect to gravity in response to input provided from said orientation sensors;
identifying the uppermost display edge corresponding to the identified operative orientation;
displaying an upright image on said display;
obtaining ambient light signals from one or more photosensors adjacent to the uppermost display edge; and
controlling the display based on the values of the ambient light signals.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 shows an example display device having ambient light photosensors for selectively determining a level of ambient light according to a given orientation of the device.

FIG. 2 shows the example display device of FIG. 1 after a rotation of 90 degrees.

FIG. 3 is an example block diagram showing the components of a display device according to the present disclosure.

FIG. 4 is an example block diagram showing the components of a mobile computing device configured according to the present disclosure.

FIG. 5 is a flow chart illustrating an example method of controlling a display based on signals obtained from ambient light sensors.

FIG. 6 shows an alternative embodiment of an example display device having one or more ambient light photosensors arranged on side portions of the display device for selectively determining a level of ambient light according to a given orientation of the device.

FIG. 7 shows another alternative embodiment of an example display device having one or more ambient light photosensors integrated with display elements of the display device for selectively determining a level of ambient light according to a given orientation of the device.

FIG. 8 shows an example embodiment in which ambient light photosensors are located in the corners of a display device, such that each display edge has two associated ambient light photosensors.

FIGS. 9a and 9b illustrate two views of an example display device in which each display edge has two associated ambient light photosensors.

FIGS. 10a and 10b illustrate two views of an example convertible ultrabook device having two predominant orientations, where an ambient light sensor is provided for each predominant orientation.

FIGS. 11a and 11b illustrate two views of another example convertible ultrabook device having two predominant orientations, where an ambient light sensor and a separate webcam are provided for each predominant orientation.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure. It should be understood that the order of the steps of the methods disclosed herein is immaterial so long as the methods remain operable. Moreover, two or more steps may be conducted simultaneously or in a different order than recited herein unless otherwise specified.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

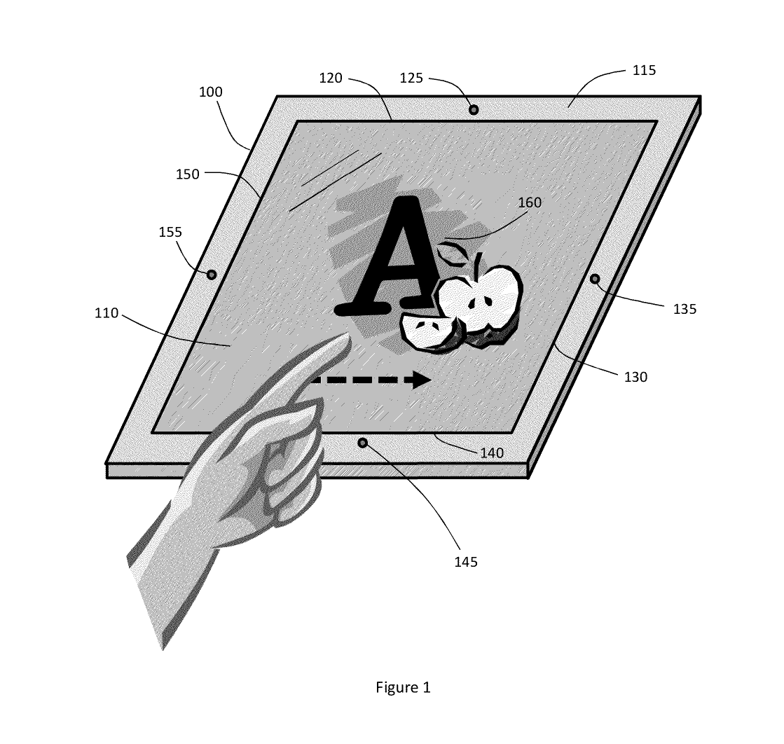

FIG. 1 illustrates a display device according to an example embodiment of the present disclosure. Display device 100, shown by way of example as a tablet computing device, includes display 110 having display edges 120, 130, 140 and 150 that define the perimeter of display 110. Display 100 may optionally include non-display bevel portion 115, which may optionally be touch sensitive for controlling the device 100 and/or display 120.

Display device 100 also includes one or more orientation sensors for determining an orientation of the device with respect to gravity, such that displayed image 160 may be dynamically oriented. Device 100 includes a plurality of photosensors 125, 135, 145 and 155 that are suitable for detecting an amount or level of ambient light. In one embodiment, at least one photosensor is provided adjacent to each edge of display 110.

The layout of the photosensors, and the selective use of signals from the various photosensors, enables a determination of the ambient light level that is substantially immune from gesture-related sensor occlusion. Referring to FIG. 1, a gesture is illustrated in which the user is swiping a finger across the display in order to provide input to the device. For example, the gesture shown in the Figure may be provided to “turn” the page of an electronic book. If the device had only been equipped with a single photosensor adjacent to the lowermost display edge (such as photosensor 145), then the gesture could generate an artifact, for example, resulting in inadvertent dimming of display 110.

In some embodiments of the present disclosure, the amount of ambient light is determined substantially or entirely by the signal generated by the one or more photosensors residing adjacent to the uppermost edge (with respect to gravity) of the display. In the embodiment illustrated in FIG. 1, for example, the ambient light level is determined entirely, or in part, by interrogating the signal generated by photosensor 125. This ambient light level is employed for controlling an aspect of the display, such as the brightness of the display.

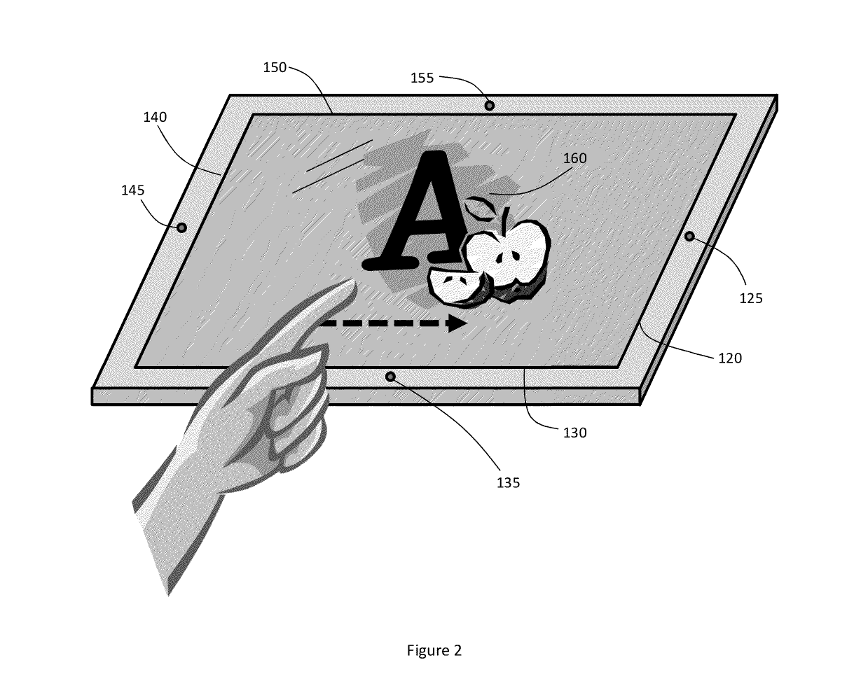

FIG. 2 shows device 100 after a clockwise rotation of 90 degrees. The new orientation is sensed by the one or more orientation sensors residing within device 100, and the image 160 on the display is rotated accordingly so that it is orientated in a substantially vertical direction.

In this new orientation, display edge 150 is now the uppermost display edge, which is identified by the device based on the newly determined device orientation. Having identified the new uppermost display edge as segment 150, the ambient light level is subsequently determined based on the signal obtained from photosensor 155. As shown in FIG. 2, this photosensor is not obstructed by a user's hand during gestures made by the user.

It is also to be noted that the gesture shown in FIG. 2 would not result in occlusion of sensors 125 and 145, located adjacent to lateral display edges 120 and 140, respectively. Similarly, in FIG. 1, the illustrated gesture would not result in occlusion of sensors 135 and 155, located adjacent to lateral display edges 130 and 150, respectively. Accordingly, it is to be understood that in some embodiments, the determination of an ambient light level may be based on the signal from the uppermost sensor, and also based on signals from additional sensors. In such cases, weighing factors may be applied to the signals from the sensors. For example, the sensor signals may be processed such that the largest weight is applied to the uppermost sensor or sensors. In another example, a weight of zero may be applied to the lowermost sensor or sensors.

Although example display device 100 shown in FIGS. 1 and 2 is a tablet computing device, other display devices may be employed according to embodiments of the present disclosure, including, but not limited to, electronic reading devices (e-readers), smartphones, convertible ultrabooks, and other display devices that may be oriented in a plurality of orientations when in use. For example, in some implementations, the display device may be a consumer media presentation device. In other implementations, the display device may be configured for professional use, such as, but not limited to, use in medical image display and/or analysis.

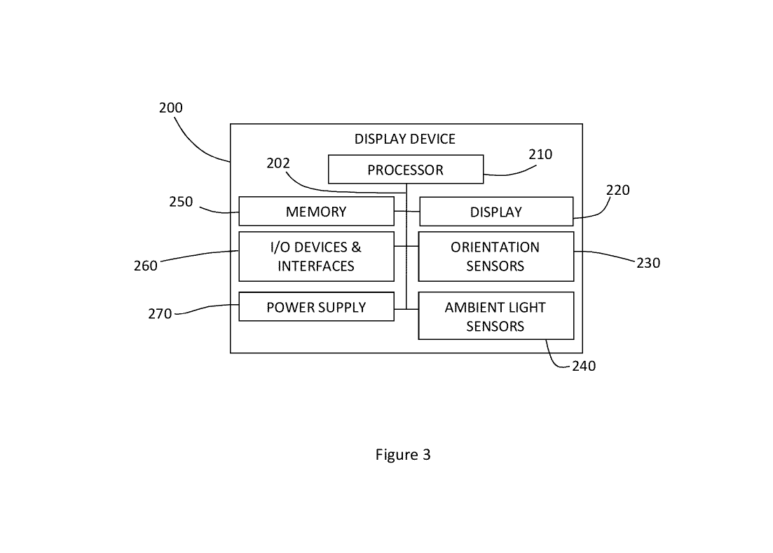

Referring now to FIG. 3, a simplified schematic of a display device is provided. Display device 200 includes processor 210, display 220, orientation sensors 230, ambient light sensors 240, memory 250, optional input/output devices and interfaces 260, and power supply 270, which may be operatively connected via bus 202. Although bus 202 is depicted as a single connection between all of the components, it will be appreciated that the bus 202 may represent one or more circuits, devices or communication channels which link two or more of the components.

Processor 210 may be any suitable processor or processing circuitry, and may include one or more processing cores. For example, in some embodiments, the processor 210 may be a Texas Instruments' OMAP4 series processor, Apple® A4 processor, NVIDIA Tegra 2 processor, Qualcomm Snapdragon MSM8260 processor, Intel® Core™ 2 Duo processor, and may be configured to process data and execute applications and programs.

Display 220 may be a display assembly that include a display device, such as a liquid crystal display (LCD), electronic ink, gas plasma, light emitting diode (LED), organic light emitting diode (OLED), active-matrix organic light-emitting diode (AMOLED), or any other type of display used with a computing device. Display 220 may also include a touch sensitive screen arranged to receive input from an object such as a stylus or a digit from a human hand.

Display 220 is coupled to processor 210 which, in turn, controls the operation of display 220. In some embodiments, display 220 may include or take the form of a dedicated processor, such as a graphical processing unit (GPU) for processing data for display and/or generally controlling the operations of the display. Display 220 may include multiple hardware layers configured to provide a visual output. In some embodiments, display 220 may include a backlight layer that provides the backlighting for the display assembly.

Orientation sensors 230 may include one or more accelerometers, such as a three-axis accelerometer. Those skilled in the art will readily appreciate that other types of orientation sensors may be alternatively or additionally employed, such as gyroscopes and Hall Effect sensors.

Ambient light photosensors 240 may be any suitable photodetector for generating an electrical signal (such as a voltage) that is indicative of the amount of ambient light, such that at least one photosensor is provided for each edge of display 220. Suitable yet non-limiting examples of ambient light photosensors include photodiodes, such as silicon photodiodes. As described below, an imaging sensor (such as a webcam) may also be configured to perform as an ambient light photosensor.

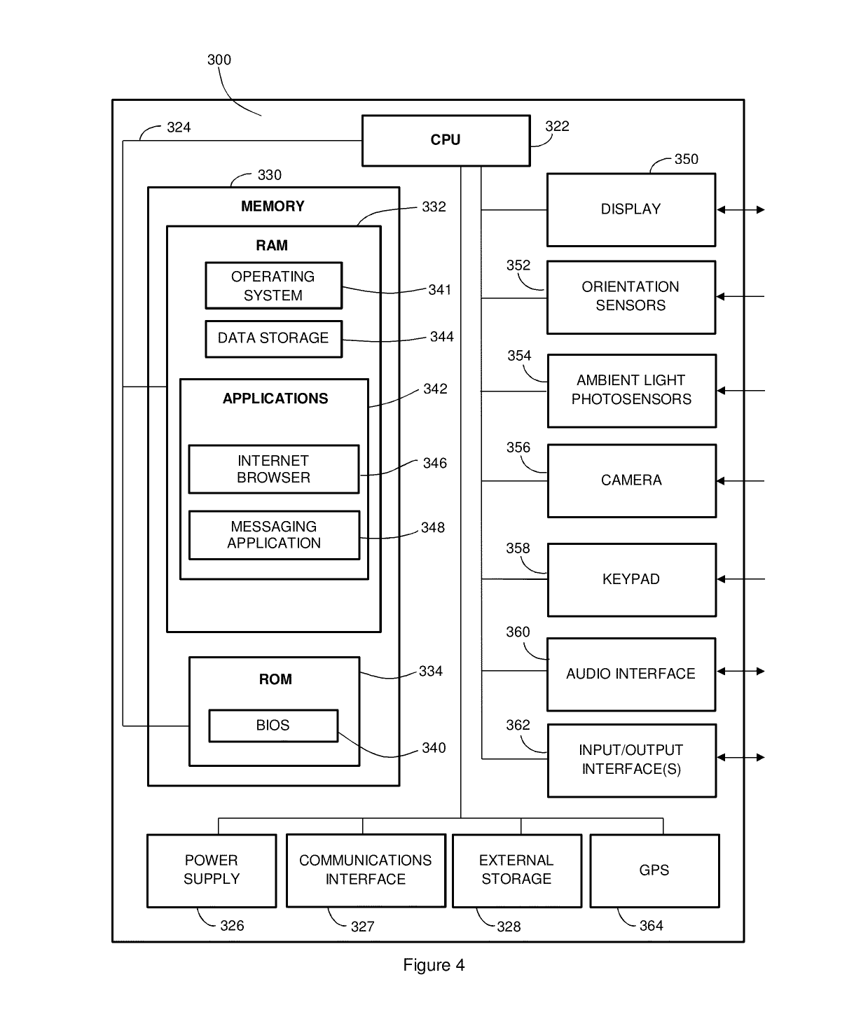

FIG. 4 illustrates another embodiment of a mobile computing device 200 for implementing the devices and methods described in the present disclosure. Mobile computing device 300 may include many more or less components than those shown in FIG. 4. However, the components shown are sufficient to disclose an illustrative embodiment for practicing the present disclosure.

As shown in the figure, mobile computing device 300 includes a processing unit (CPU) 322 in communication with a mass memory 330 via bus 324. Mobile computing device 300 also includes a power supply 326, a display 350, one or more orientation sensors 352, and a plurality of ambient light photosensors 354, as described above. Mobile computing device 300 may further include one or more cameras 356, keypad 358, an audio interface 360, an input/output interface 362, a communications interface 327, external storage 328 and a global positioning systems (GPS) receiver 364. Power supply 326 provides power to mobile computing device 300. A rechargeable or non-rechargeable battery may be used to provide power. The power may also be provided by an external power source, such as an AC adapter or a powered docking cradle that supplements and/or recharges a battery.

One or more cameras 356 maybe arranged to capture video images, such as a still photo, a video segment, an infrared video, or the like. For example, camera 356 may be coupled to a digital video camera, a web-camera, or the like. Camera 356 may comprise a lens, an image sensor, and other electronics. Image sensors may include a complementary metal-oxide-semiconductor (CMOS) integrated circuit, charge-coupled device (CCD), or any other integrated circuit for sensing light. As noted above, camera 356 may also be configured to detect a signal representative of an amount of ambient light, thereby acting as an ambient light photosensor.

Mobile computing device 300 may optionally communicate wirelessly using communications interface 327, such as with a wireless router, remote base station (not shown), or directly with another computing device. Communications interface 327 includes circuitry for coupling mobile computing device 300 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Communications interface 327 is sometimes known as a transceiver, transceiving device, or network interface card (NIC).

Keypad 358 may be any input device arranged to receive input from a user. For example, keypad 356 may include a push button numeric dial, or a keyboard. Keypad 358 may also include command buttons that are associated with selecting and sending images. Keypad 358 may also be virtually rendered on display 350, provided that display 350 is touch-sensitive.

Audio interface 360 is arranged to produce and receive audio signals such as the sound of a human voice. For example, audio interface 360 may be coupled to a speaker and microphone (not shown) to enable telecommunication with others and/or generate an audio acknowledgement for some action.

Mobile computing device 300 also includes input/output interface 362 for communicating with external devices, such as a headset, or other input or output devices not shown in FIG. 3. Input/output interface 360 can utilize one or more communication technologies, such as USB, infrared, Bluetooth™, Wi-Fi, Zigbee, or the like, or may be a haptic interface arranged to provide tactile feedback to a user of the mobile computing device.

Mass memory 330 includes a RAM 332, a ROM 334, and other storage means. Mass memory 330 illustrates another example of computer storage media for storage of information such as computer readable instructions, data structures, program modules or other data. Mass memory 330 stores a basic input/output system (“BIOS”) 340 for controlling low-level operation of mobile computing device 300. The mass memory also stores an operating system 341 for controlling the operation of mobile computing device 300. It will be appreciated that this component may include a general purpose operating system such as a version of UNIX, or LINUX™, or a specialized client communication operating system such as iOS™, Android™, Windows Mobile™ or the Symbian® operating system. The operating system may include, or interface with a Java virtual machine module that enables control of hardware components and/or operating system operations via Java application programs.

Memory 330 further includes one or more data storage elements 344, which can be utilized by mobile computing device 300 to store, among other things, applications 342 and/or other data. For example, data storage 344 may also be employed to store information that describes various capabilities of mobile computing device 300. The information may then be provided to another device based on any of a variety of events, including being sent as part of a header during a communication, sent upon request, or the like. Moreover, data storage 344 may also be employed to store personal information including but not limited to address lists, contact lists, personal preferences, or the like.

Applications 342 may include computer executable instructions which, when executed by mobile computing device 300, transmit, receive, and/or otherwise process messages (e.g., SMS, MMS, IM, email, and/or other messages), multimedia information, and enable telecommunication with another user of another mobile computing device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 342 may also include browser 346, and messenger 348.

Browser 346 may be configured to receive and to send web pages, forms, web-based messages, and the like. Browser 346 may, for example, receive and display (and/or play) graphics, text, multimedia, audio data, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Messenger 348 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 348 may be configured as an IM application, such as AOL Instant Messenger, Yahoo! Messenger, .NET Messenger Server, ICQ, or the like. In one embodiment messenger 372 may be configured to include a mail user agent (MUA) such as Elm, Pine, MH, Outlook, Eudora, Mac Mail, Mozilla Thunderbird, or the like. In another embodiment, messenger 348 may be a client application that is configured to integrate and employ a variety of messaging protocols. In one embodiment, messenger 348 may employ various message boxes to manage and/or store messages.

Embodiments of the disclosure can be implemented via the microprocessor(s) and/or the memory. For example, the functionalities described above can be partially implemented via hardware logic in the microprocessor(s) and partially using the instructions stored in the memory. Some embodiments are implemented using the microprocessor(s) without additional instructions stored in the memory. Some embodiments are implemented using the instructions stored in the memory for execution by one or more general purpose microprocessor(s). Thus, the disclosure is not limited to a specific configuration of hardware and/or software.

At least some aspects disclosed herein can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices.

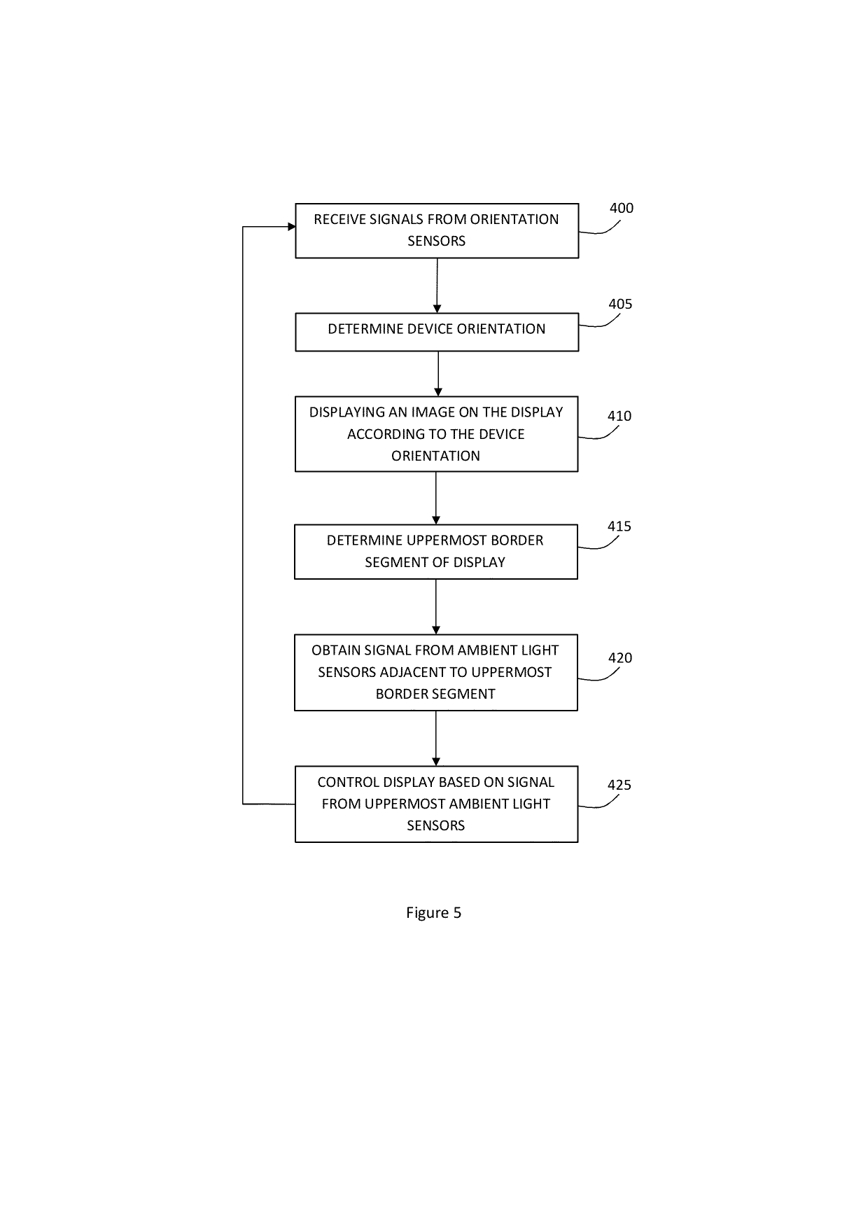

FIG. 5 provides a flow chart illustrating an example implementation of controlling a display of a display device according to an embodiment of the disclosure. In step 400, signals are received from the one or more orientation sensors, and these signals are processed by the processor in step 405 to determine an orientation of the display device. An image may then be displayed on the display in step 410, where the image is oriented according to the orientation determined in step 405.

The device orientation is subsequently employed by the processor to determine the uppermost (with respect to gravity) display edge of the display in step 415. In cases where the device is oriented in a horizontal or near-horizontal orientation, the most recently sensed orientation may be employed for identifying the uppermost display edge. The signals from one or more ambient light photosensors adjacent and/or proximal to the uppermost display edge are obtained in step 420, and subsequently employed in step 425 to control the display. This step of controlling the display may include controlling an intensity of light emitted from pixels forming the display, and/or an intensity of a backlight employed to generate or illuminate the display. The preceding steps may be repeated one or more times in order to provide continuous display control in response to changes in device orientation and/or ambient light levels. It is to be understood that steps 415 and 420 may be performed before performing step 410.

The preceding embodiments have disclosed devices and methods in which the signals from the one or more ambient light photosensors adjacent to the uppermost display edge are employed. In other embodiments, the signal from the ambient light photosensors adjacent and/or proximal to the uppermost display edge may be combined with signals from other ambient light photosensors, where the step of combining the signals includes applying weighting the signals from the ambient light photosensors such that the signals from the ambient light photosensors adjacent to the uppermost display edge receive the highest weight.

For example, in one example implementation, a weighted measure of ambient light may be generated based on signals from multiple ambient light photosensors. The measure may be based on signals from the ambient light photosensors such that the signals from the ambient light photosensors adjacent to the uppermost display edge receive the highest weight when forming the weighted measure, the signals from the ambient light photosensors adjacent to the middle display edges receive an intermediate weight, and the signals from the ambient light photosensors adjacent to the lowermost display edges receive the lowest weight. In one example implementation, the weighted signals may be added, such that the weight factors applied to the individual signals are fractions that sum to unity. The device may be preprogrammed with pre-defined weights. Alternatively, the weights may be user-configurable.

In yet another embodiment, in which a peripheral portion of the display device (such as a bezel) is touch sensitive, the signal from the ambient light photosensor adjacent to the uppermost display edge may combined with the signal from one or more ambient light photosensors that are adjacent to one or more additional display edges, such that the additional display edges are adjacent to peripheral portions of the display device that are not being touched (as determined based on input from the touch sensitive peripheral portions). The signals may be combined (for example, averaged, or weighted and summed to form a weighted average as disclosed above) to provide a composite ambient light measure.

In other embodiments, additional aspects of controlling the display may be user configurable. For example, user input may be received for defining a maximum and/or minimum brightness level to be employed when automatically controlling the display brightness in response to the signals from the ambient light photosensors.

Although the example devices illustrated in FIGS. 1 and 2 include ambient light photosensors that reside within the bezel 115 of the device, it is to be understood that the placement of the photosensors is not limited to the bezel. In alternative embodiments, one or more of the photosensors may be located adjacent to the display edge but in a location other than the display bezel.

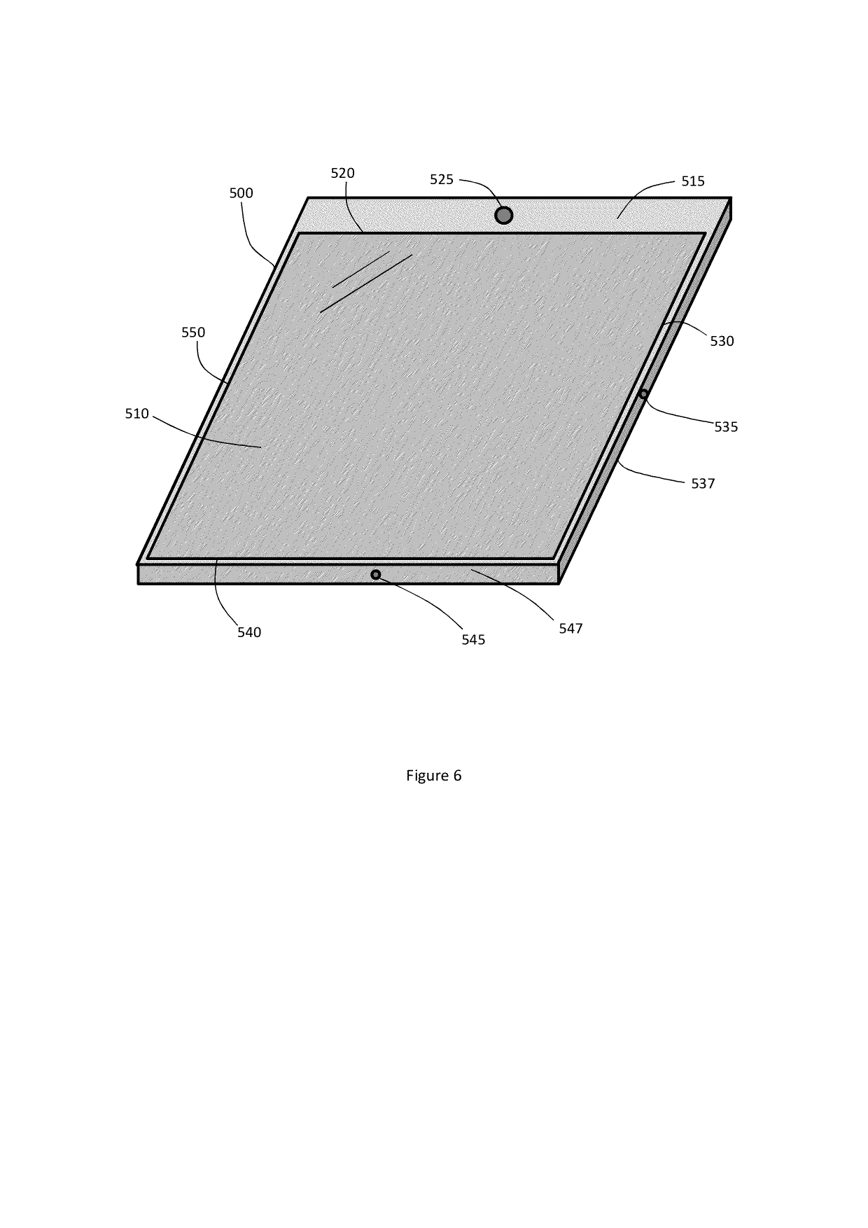

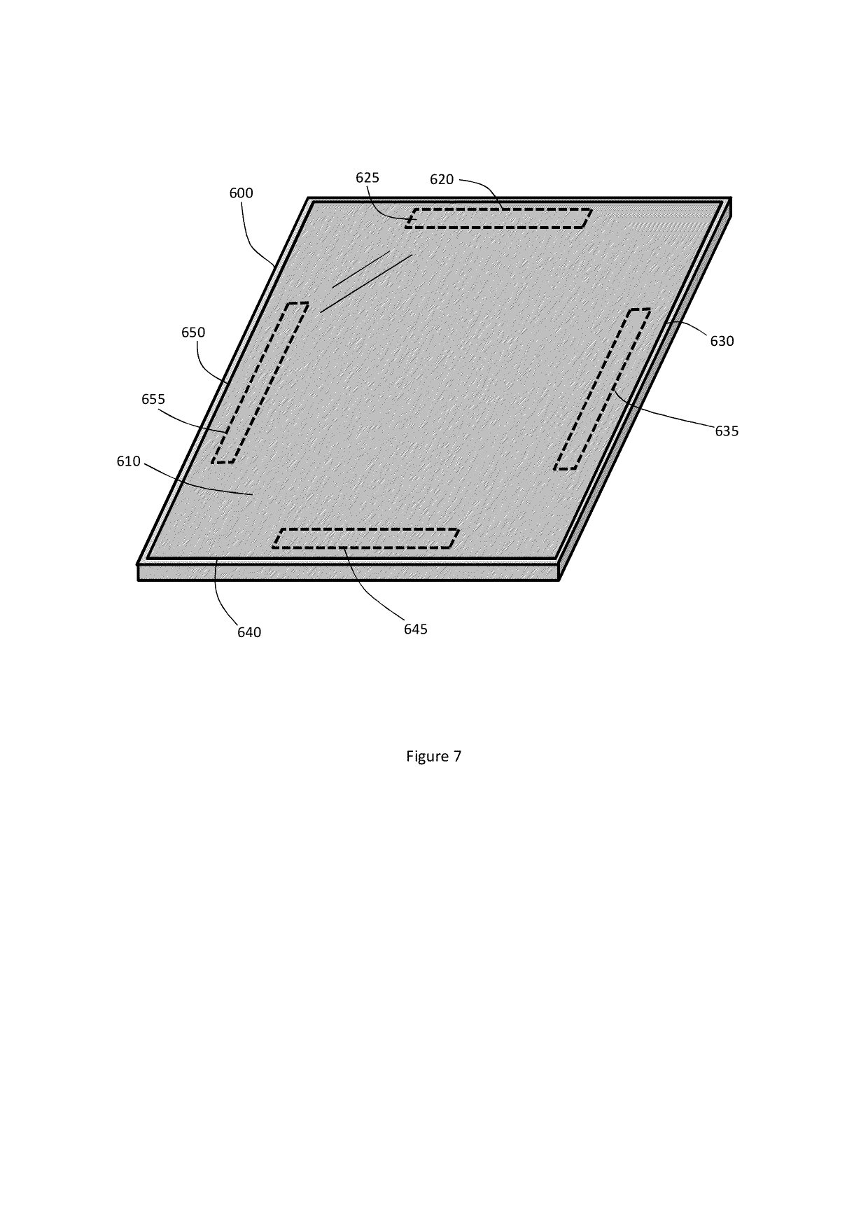

Two such alternative example embodiments are illustrated in FIGS. 6 and 7. In FIG. 6, an example embodiment is illustrated in which device 500 includes one ambient light photosensor 525 (which may be a camera) located proximal to one display edge 520 on a bezel 515, while the remaining three ambient light photosensors 535, 545 and 555 (not shown), corresponding to display edges 530, 540 and 550, respectively, are located on lateral sides of the device (lateral sides 537 and 547 are shown in the Figure). Such lateral sides may form beveled surfaces relative to the top surface of display 500, such that photosensors 535, 545 and 555 may be directed towards a user operating the device.

In another embodiment, one or more of the ambient light photosensors may be directly integrated with the elements of the display. FIG. 7 illustrates such an alternative embodiment, where ambient light photosensors, occupying areas 625, 635, 645 and 655, and associated with display edges 620, 630, 640 and 650, respectively, are be integrated onto a substrate forming a layer of display 610. In one example embodiment, the substrate may be low temperature polysilicon (LTPS) or amorphous silicon (aSi:H), which is used for the display backplane in some display devices. FIG. 7 illustrates an embodiment where, for each display edge defining the display perimeter, a set of ambient light photosensors are provided and integrated with the device pixels in the areas shown by the dashed line.

In another embodiment, each display pixel of the display may include a corresponding photosensor, and the device may be programmed such that one or more photosensors adjacent and/or proximal to a given display edge are interrogated for determining the ambient light level. The integration of the display pixel with the ambient light photosensor is possible because the thin film transistor (TFT) and diode devices commonly used in various displays are themselves photosensitive. Such an embodiment provides a more compact solution without requiring space on the device for housing discrete photosensors; optionally without a bezel portion surrounding the display (although in some cases it will be preferable to include a camera, similar to the arrangement shown in FIG. 6).

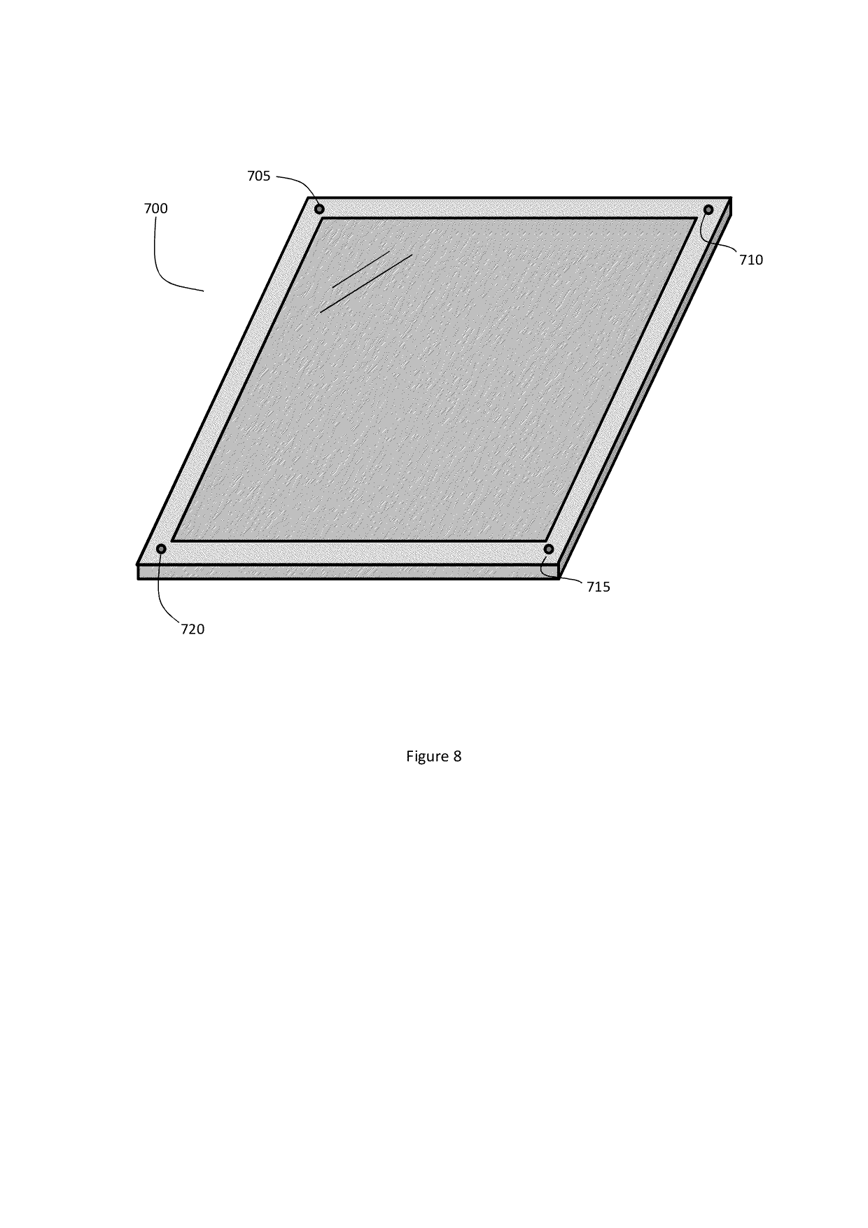

FIG. 8 illustrates an example implementation of a display device 700 in which four ambient light photosensors 705, 710, 715 and 720 are located in the corners of the device. In such an embodiment, each display edge has two associated ambient light photosensors. For example, when device 700 is oriented as shown in FIG. 8, ambient light photosensors 705 and 710 may be interrogated for determining the ambient light level.

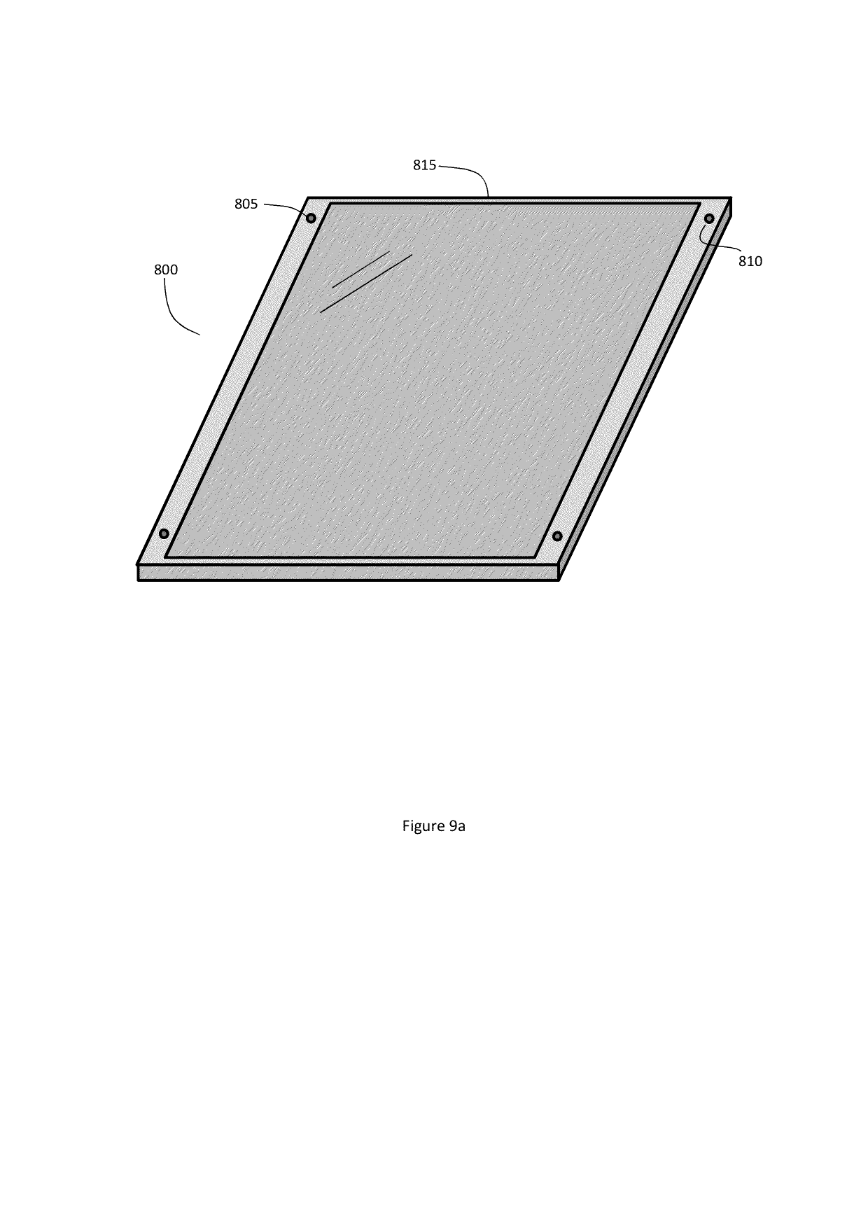

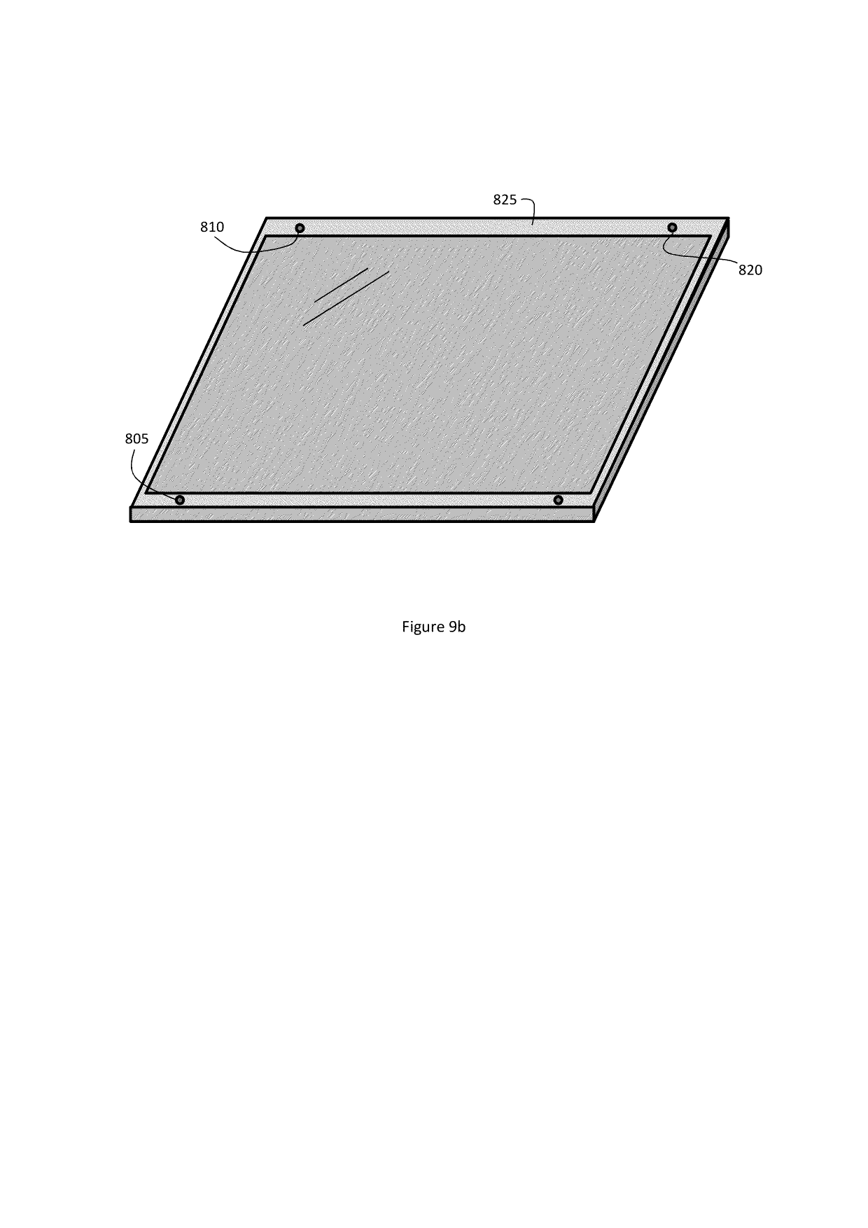

FIGS. 9a and 9b show two orientations of an example display device 800, for which each display edge has associated therewith two ambient light photosensors. As shown in FIG. 9a, photosensors 805 and 810 are proximal to uppermost edge 815, while in FIG. 9b, in which device 800 is rotated clockwise by 90 degrees, photosensors 10 and 820 are proximal to uppermost edge 825.

It is to be understood that while the preceding embodiments illustrate example implementations involving display devices configured to have four operative orientations, the number of operative orientations is not limited to four, and may be any number greater than one. For example, in one illustrative embodiment, the display device may have four sides, but the display may be configured to be display images in two predominant orientations. Examples of two predominant orientations include (a) two portrait orientations, (b) two landscape orientations, and (a) one portrait orientation and one landscape orientation.

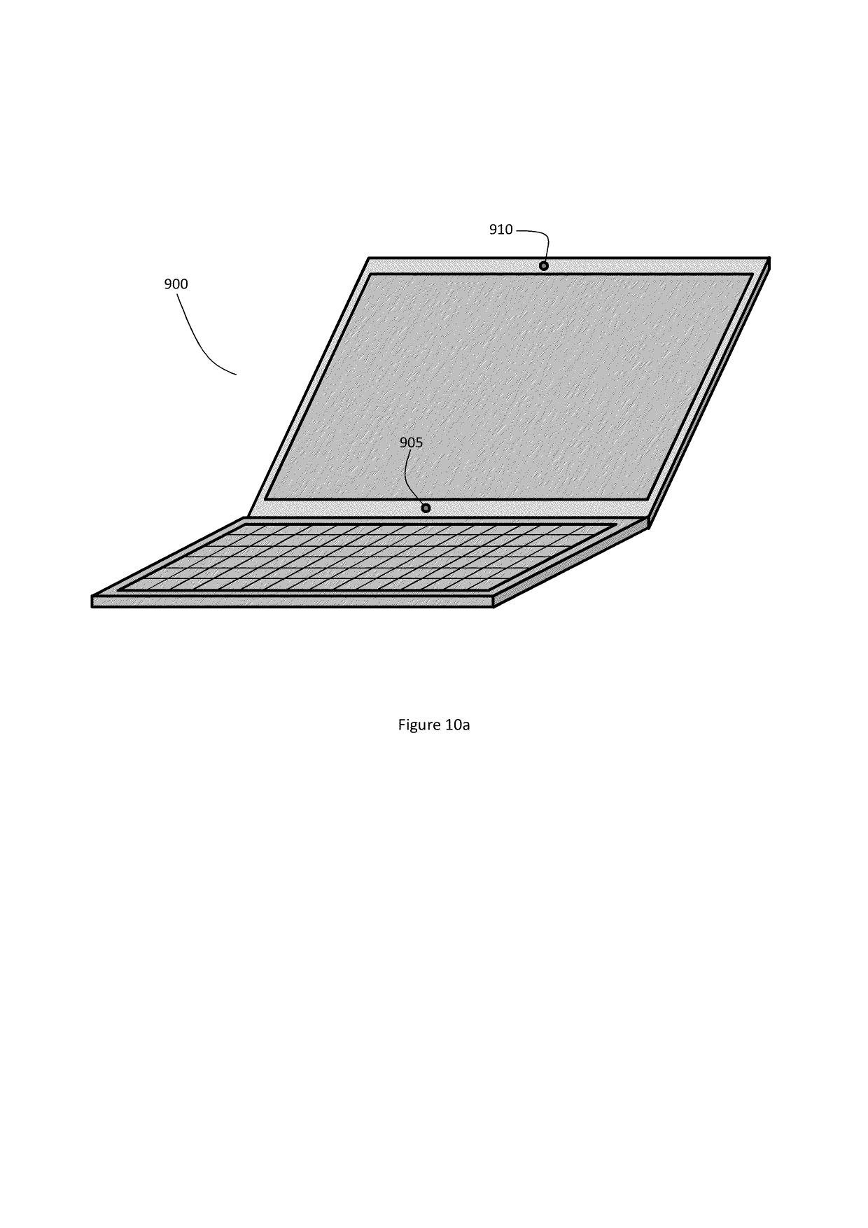

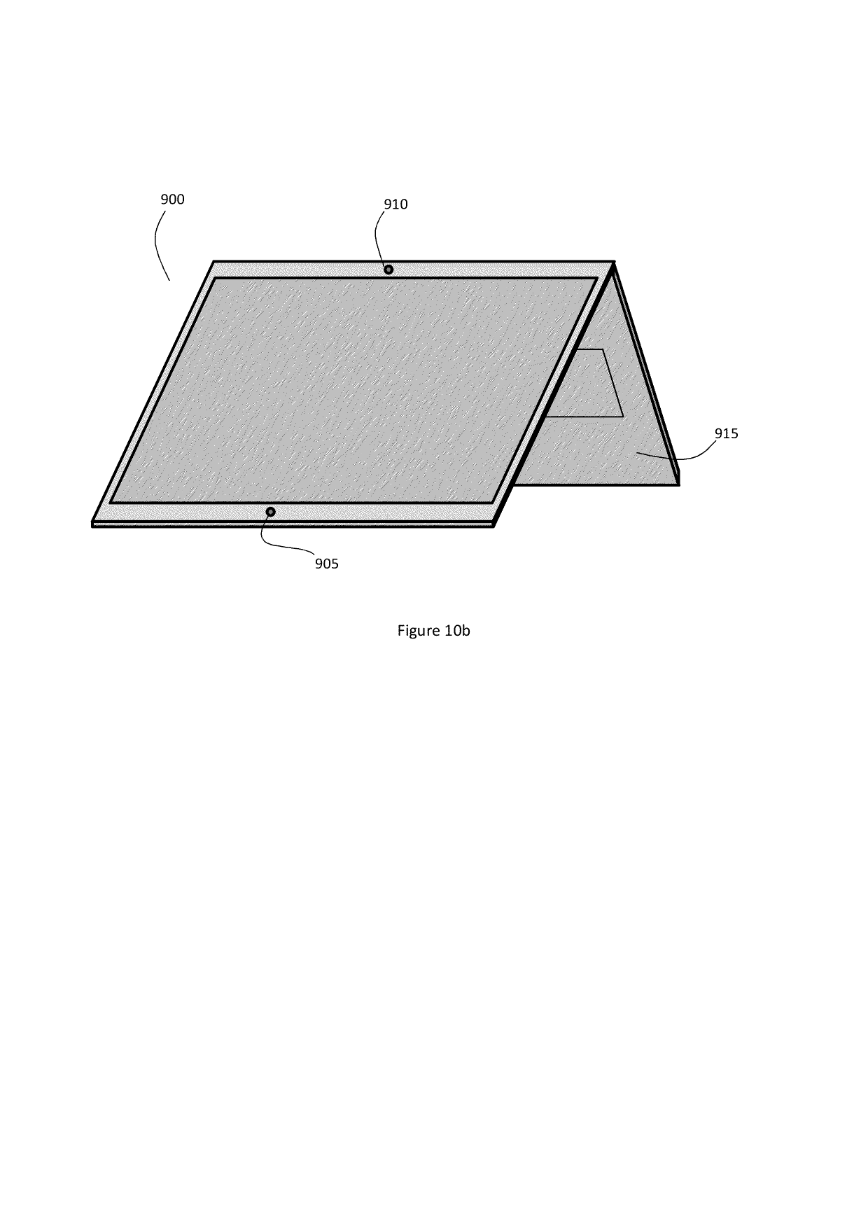

FIGS. 10a and 10b illustrate example implementations of a convertible ultrabook device that includes multiple ambient light photosensors for sensing the ambient light level in response to device orientation in two predominant landscape orientations. As shown in FIG. 10a, convertible ultrabook 900 includes ambient light photosensors 905 and 910. When the device is oriented in the laptop mode, as shown in FIG. 10a, ambient light photosensor 910 is interrogated to measure the ambient light levels. However, when the device is oriented in another predominant orientation, the “tent” mode, as shown in FIG. 10b, ambient light photosensor 905 is interrogated to measure the ambient light levels. Side 915 in FIG. 10b is the bottom surface of the keyboard component of the device.

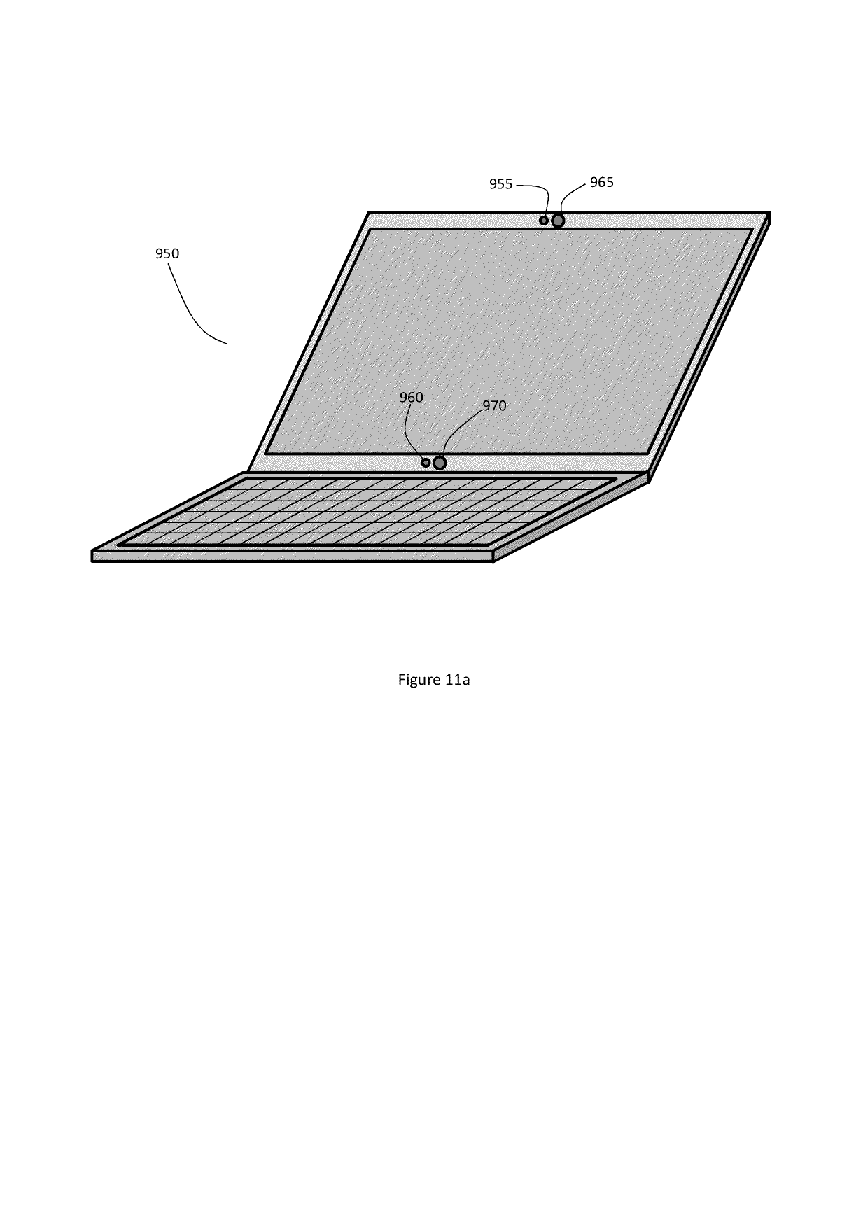

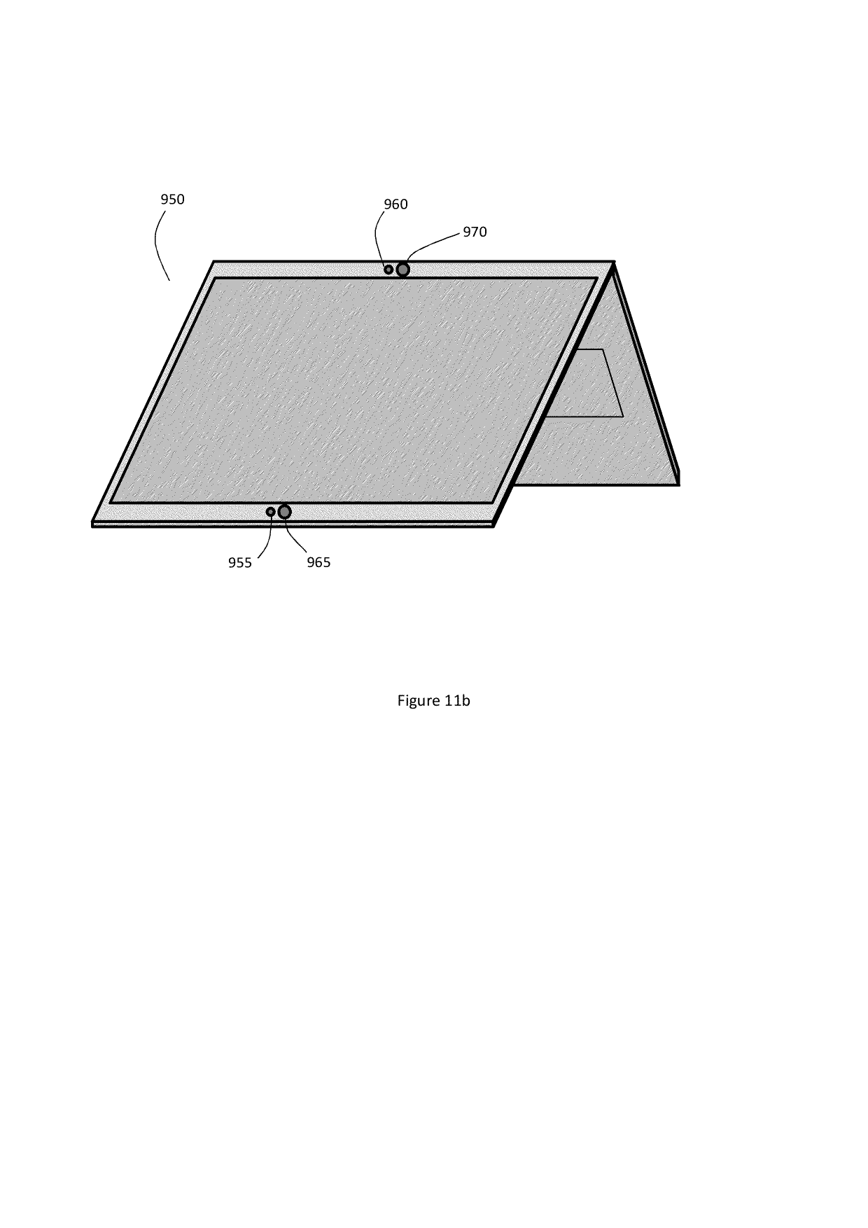

As noted above, in some embodiments, the photosensors may be imaging sensors that are configured for imaging and/or ambient light sensors. In the embodiments illustrated in FIGS. 10a and 10b, ambient light sensors 905 and 910 may be imaging sensors (e.g. webcams) that are operatively selected based on the sensed orientation of the device. Such an embodiment enables the use of the device for imaging applications, such as Skype, Facetime, or other video communications applications, when the device is in the tent mode. FIGS. 11a and 11b show alternative embodiments in which convertible ultrabook device 950 includes both ambient light photosensors 955 and 960, and imaging sensors (webcams) 965 and 970, which are operatively selected based on device orientation for ambient light sensing and imaging applications, respectively.

The specific embodiments described above have been shown by way of example, and it should be understood that these embodiments may be susceptible to various modifications and alternative forms. For example, although embodiments of the disclosure have been illustrated with rectangular, four-sided displays, it is to be understood that other display shapes and geometries are also envisioned by the present disclosure. It should be further understood that the claims are not intended to be limited to the particular forms disclosed, but rather to cover all modifications, equivalents, and alternatives falling within the spirit and scope of this disclosure.

Therefore what is claimed is:

1. A mobile display device comprising:
a display configured for displaying an upright image in two or more operative orientations, each operative orientation having associated therewith a display edge that is positioned in an uppermost orientation;
one or more orientation sensors;
a plurality of photosensors configured to detect ambient light, wherein at least one photosensor is located proximal to each said display edge; and
processing circuitry operatively connected to said display, said orientation sensors, and said photosensors;
wherein said processing circuitry is configured to:
identify the operative orientation of said device with respect to gravity in response to input provided from said orientation sensors;
identify the uppermost display edge corresponding to the identified operative orientation;
display an upright image on said display; and
control said display according to input from one or more photosensors proximal to the identified uppermost display edge.

2. The device according to claim 1 wherein one or more of said photosensors are located on a bezel surrounding said display.

3. The device according to claim 2 wherein said bezel is touch sensitive.

4. The device according to claim 1 wherein one or more of said photosensors are located on a side of said device.

5. The device according to claim 4 wherein said side of said device is beveled.

6. The device according to claim 1 wherein said display is a touch sensitive display.

7. The device according to claim 1 wherein at least one of said photosensors is an imaging sensor.

8. The device according to claim 1 wherein at least one of said photosensors is a non-imaging photosensor.

9. The device according to claim 1 wherein said display is substantially rectangular in shape.

10. The device according to claim 1 wherein said display is configured to be oriented in four operative orientations.

11. The device according to claim 1 wherein one or more of said photosensors are integrated with elements of said display.

12. The device according to claim 1 wherein the said processing circuitry is further configured to control the brightness of the display according to input from the one or more photosensors adjacent to the identified uppermost display edge.

13. The device according to claim 12 wherein said processing circuitry is further configured to control said display according to a weighted measure based on input from one or more photosensors adjacent to the identified uppermost display edge and input from one or more photosensors adjacent to at least one additional display edge, where the input from the one or more photosensors adjacent to uppermost display edge receives the highest weight.

14. The mobile display device according to claim 1, wherein the device is selected from the group consisting of a tablet, smartphone, electronic reader, and convertible ultrabook.

15. A computer implemented method of controlling a display on a mobile display device;
the mobile display device comprising:
a display configured for displaying an upright image in two or more operative orientations, each operative orientation having associated therewith a display edge that is positioned in an uppermost orientation;
one or more orientation sensors;
a plurality of photosensors configured to detect ambient light, wherein at least one photosensor is located proximal to each said display edge; and
processing circuitry operatively connected to said display, said orientation sensors, and said photosensors;
the method comprising:
identifying the operative orientation of said device with respect to gravity in response to input provided from said orientation sensors;
identifying the uppermost display edge corresponding to the identified operative orientation;
displaying an upright image on said display;
obtaining ambient light signals from one or more photosensors adjacent to the uppermost display edge; and
controlling the display based on the values of the ambient light signals.

16. The method according to claim 15 wherein the step of controlling the display includes controlling a brightness of the display based on the values of the ambient light signals.

17. The method according to claim 15 wherein the ambient light signals are first ambient light signals, the method further comprising:
obtaining additional ambient light signals from one or more photosensors adjacent to one or more another display edges;
generating a weighted ambient light measure based on the first ambient light signals and the additional ambient light signals, such that the first ambient light signals receive the highest weight when generating the weighted measure; and
controlling the display based on the weighted measure.

18. The method according to claim 15 wherein the ambient light signals are first ambient light signals, the method further comprising:
obtaining additional signals from one or more ambient light photosensors that are adjacent to one or more additional display edges, such that the additional display edges are not adjacent to peripheral portions of the display device that are being touched; and
forming a composite ambient light measure based on the first ambient light signals and the additional signals.
